(19) United States
(12) Patent Application Publication
(10) Pub. No.: US 2017/0164791 A1
(43) Pub. Date: Jun. 15, 2017

(54) Process of Fabrication of a Shower Tray and a Shower Cubicle, Shower Tray and a Shower Cubicle Made according to this Process

(71) Applicant: Crea Diffusion, Solgne (FR)

(72) Inventor: Francois Provence, Liocourt (FR)

(21) Appl. No.: 14/968,986

(22) Filed: Dec. 15, 2015

(51) Int. Cl. A47K 3/40; B29C 65/56; B29C 51/08

(52) U.S. Cl. CPC A47K 3/405; B29C 51/08; B29C 65/562; B29K 2033/04

(57) ABSTRACT

A process of fabrication of a shower tray wherein it comprises the steps of: selecting a plate in thermoplastic material; cutting at least one corner; heating the plate to soften it; forming the plate on a mold to raise the convex limit at the at least one corner and the edges between the cuts, the junction between a central portion of the plate, forming a bottom, and each raised edge being curved; and joining raised edges at each corner.

### BACKGROUND

The invention is related to a process of fabrication of a shower tray and a shower cubicle using thermoplastic material. It is related also to a shower tray and a shower cubicle made according to this process.

Shower trays in thermoplastic material in particular in or with acrylic resin are well known. Usually, the acrylic resin is used for the visible surface in a thin layer, and reinforcing layers are used under the acrylic layer. Such trays are molded along a complex process of fabrication and need onerous tools. Such a process is reserved to mass production.

For smaller or unitary production, it is possible to assemble parts of material in plate, said parts being cut and tooled at the needed dimensions before to be bonded. The document FR 2 802 075 discloses such a tray, with resin material plates. Plates used for this tray are usually structural parts as there is no need to add reinforcing parts or layers. Corian® is a material comprising acrylic resin with alumina trihydrate as filler and can be used for such a purpose.

This process requires some working hours.

In some cases, the bottom plate of the tray is thermomolded to give it a slight slope to a sink hole. The thermal cycle changes the mechanical properties of the plate, and its behavior under thermal conditions is different from the original plate. When such plates are assembled with side panels by bonding, mechanical constraints are important when the shower is used with hot water, which can imply cracks in some cases, especially along bonded joints. The bottom dilates or retracts in horizontal directions and acts on bonded junction with side panels. However, the bonded junction is more fragile than the material.

### SUMMARY

This is an aim of the invention to remedy to the problems of the prior art previously exposed. In particular, this is an aim of the invention to provide a shower tray in thermoplastic material with improved mechanical strength.

This is also an aim of the invention to provide an improved process which needs lesser investments than for molded shower trays but a better productivity than a manual process.

This is also an aim of the invention to provide a shower cubicle using such a shower tray and a process of fabrication of said shower cubicle.

With these aims in view, the invention is related to a process of fabrication of a shower tray wherein it comprises the steps of:
selecting a plate in thermoplastic material, the plate having corners;
cutting at least one corner along an outline, each outline comprising, in a plane of the plate, a first line perpendicular to one of the edges of said corner, a second line perpendicular to another of the edges of said corner, an arcuate line between the first and the second line defining a convex limit, and a first recess portion and a second recess portion joining the arcuate line and respectively the first and the second line;
heating the plate to soften it;
forming the plate on a mold by thermomolding to raise the convex limit at the at least one corner and the edges of the plate extending from said corner, in particular from the recess portions, the junction between a central portion of the plate, forming a bottom, and each raised edge being curved to form a curved junction part;
joining raised edges at each corner.

With such a process, we provide a shower tray with an improved strength thanks to the fact that the raised edges are continuous with the bottom, without bonded joint. Thus, there is no more fragile bonded junction in a zone solicited with dilatation or retraction of the bottom. The bottom and the raised edges form a shell which has a greater strength. This shell can be done with strong thickness, so that it is self-supporting without a reinforcing layer or parts. Furthermore, curved junctions between bottom and raised edges are easier to clean than sharp angles. When the corner is formed, the material of the convex limit is compressed and flows inside the recess portions, forming a portion of a cup joining the curved junctions parts between the bottom and the raised edges. The recess portions ensure the material is not too compressed during the process.

According to an improvement, raised edges are joined at a corner by bonding an angle piece between them. The angle piece is used to obstruct the remaining space between the raised edges on each side of the corner.

According to an improvement, before bonding the angle piece, the raised edges and the convex limit are milled along the first and second lines and the arcuate line to enclose the recess portion and to create three planar faces, the angle piece being bonded on said three faces. This creates clean surfaces on which the angle piece can be bonded, with a simple geometry. After milling, the recess portions disappear.

According to another improvement, the angle piece raises at the same level as the raised edges. Thus the upper edges of the tray are continuous at the corner.

According to another improvement, the junctions between the bottom and the raised edges are joined at a corner without a rounded portion. This form can be given by the mold on which the tray is formed. With such a form, the junction between the raised edges can be without a rounded portion and obtained by bonding two plates at an angle.

According to another improvement, when forming the plate, the bottom is formed in depression. This gives slight slopes to improve the flow of the used water in a direction of a drain. The slope can be given in the same operation of the thermomolding operation.

According to another improvement, the plate is made of a material comprising acrylic resin with mineral filler. The mineral filler gives more strength to the material.

According to another improvement, the mineral filler comprises alumina trihydrate and consists of more than 60% of the mass of the material. Such a material can be used without reinforcing supports. Such a material can be Corian®.

It is another object of the invention to provide a process of fabrication of a shower cubicle, wherein a shower tray as previously disclosed is used, and wherein at least one first panel is raised in prolongation of one of the raised edges. The first panel is thus a side wall of the cubicle and is in continuity with the corresponding raised edge.

According to another improvement, a second panel is raised in prolongation of one of the raised edges and joined with at least the first panel without a rounded part. First or second panels can be also in the same material as the tray, with the same thickness or a lesser one. But other material can be used.

According to another aspect, the invention concerns a shower tray in thermoplastic material, comprising:
a bottom;
raised edges along the bottom and extending from at least one corner of the bottom, the junction between the bottom and each raised edge being curved to form curved junction parts;
a bonded junction at a corner between raised edges.

According to an improvement of the shower tray, it comprises an angle piece joining raised edges bonded at least at said corner on three faces, the angle piece comprising two flanges, each flange being abutted against one of the raised edges of said corner.

According to an improvement of the shower tray, the curved junction parts are joined at a corner without a rounded portion. This form is the continuity of the angle piece or the junction between side panels.

According to an improvement, the plate is made of a material comprising acrylic resin with mineral filler.

According to an improvement, the mineral filler comprises alumina trihydrate and consists of more than 60% of the mass of the material.

According to another aspect, the invention concerns a shower cubicle in thermoplastic material, comprising:
a bottom;
raised edges along the bottom and extending from at least one corner of the bottom, the junction between the bottom and each raised edge being curved to form curved junction parts;
a bonded junction at the corner between raised edges;
at least a first panel raised in prolongation of one of the raised edges.

According to an improvement, the shower cubicle comprises an angle piece joining raised edges bonded at least at said corner on three faces, the angle piece comprising two flanges, each flange being abutted against one of the raised edges of said corner.

According to an improvement, the shower cubicle comprises a second panel raised in prolongation of one of the raised edges and joined with the first panel without the rounded portion.

### BRIEF DESCRIPTION OF THE DRAWINGS

Advantages of the invention and others objects in view will become apparent in the followed detailed description, in connection with the accompanying drawings in which:

FIG. 1 is a perspective view of a shower tray according to an embodiment of the invention;

FIG. 2 is a partial perspective view of a shower cubicle according to an embodiment of the invention;

FIG. 3 is a view of a plate for fabrication of the tray of FIG. 1;

FIG. 4 is the detail IV of FIG. 3;

FIG. 5 is a perspective view of the first transformation of the plate of FIG. 3;

FIGS. 6 to 8 are the detail VI of FIG. 5 in different states along the fabrication process.

### DETAILED DESCRIPTION

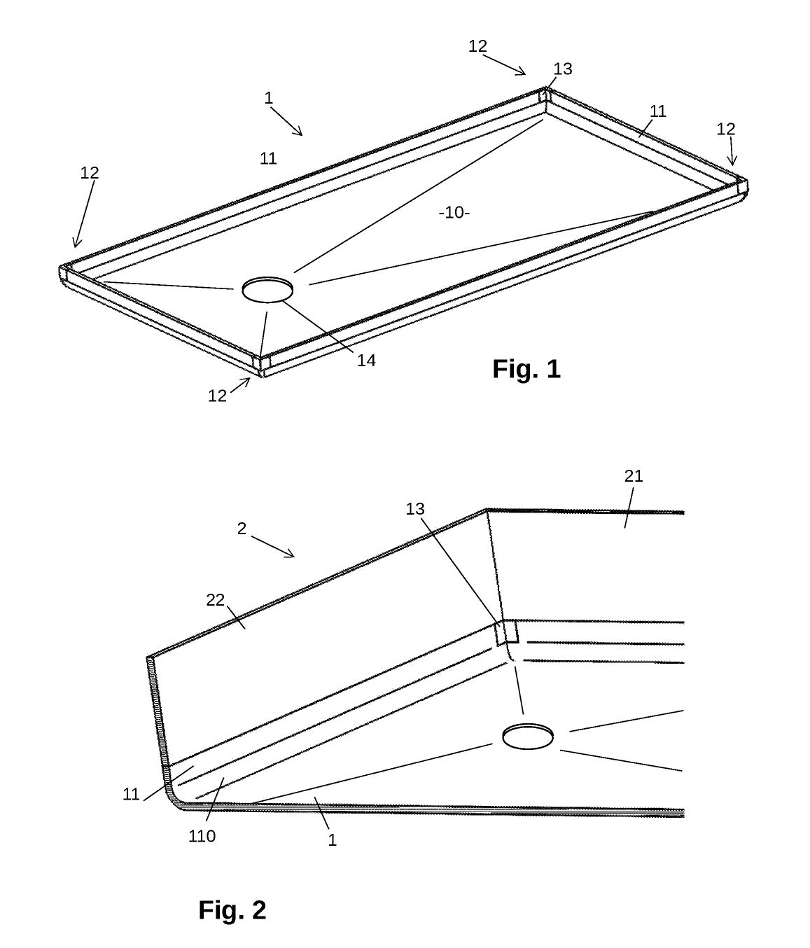

A shower tray 1 in thermoplastic material according to an embodiment of the invention is shown on FIG. 1. The shower tray 1 comprises a bottom 10 in rectangular form surrounded with four raised edges 11. Raised edges 11 are joined at the four corners 12 of the bottom 10 with curved junction parts and like a quarters of cylinder. Curved junction parts 110 are joined also together at corners 12 with miter, without rounded portion. Furthermore, the vertical part of the raised edges 11 are joined also together with an angle piece 13 joining raised edges 11 and bonded at each corner 12 on three faces. The angle piece 13, as shown on FIG. 8, comprises two flanges 131, each flange 131 being abutted against one of the raised edges 11 of the corner 12.

The thermoplastic material can be an acrylic resin with filler such as mineral filler. An example of filler is alumina trihydrate and an example of material with such a filler is Corian®. But other resin such as polyethylene, polypropylene, polycarbonate, polyester or polyimide can be used. Other fillers can also be used such as for example glass powder, talc, kaolin or mica.

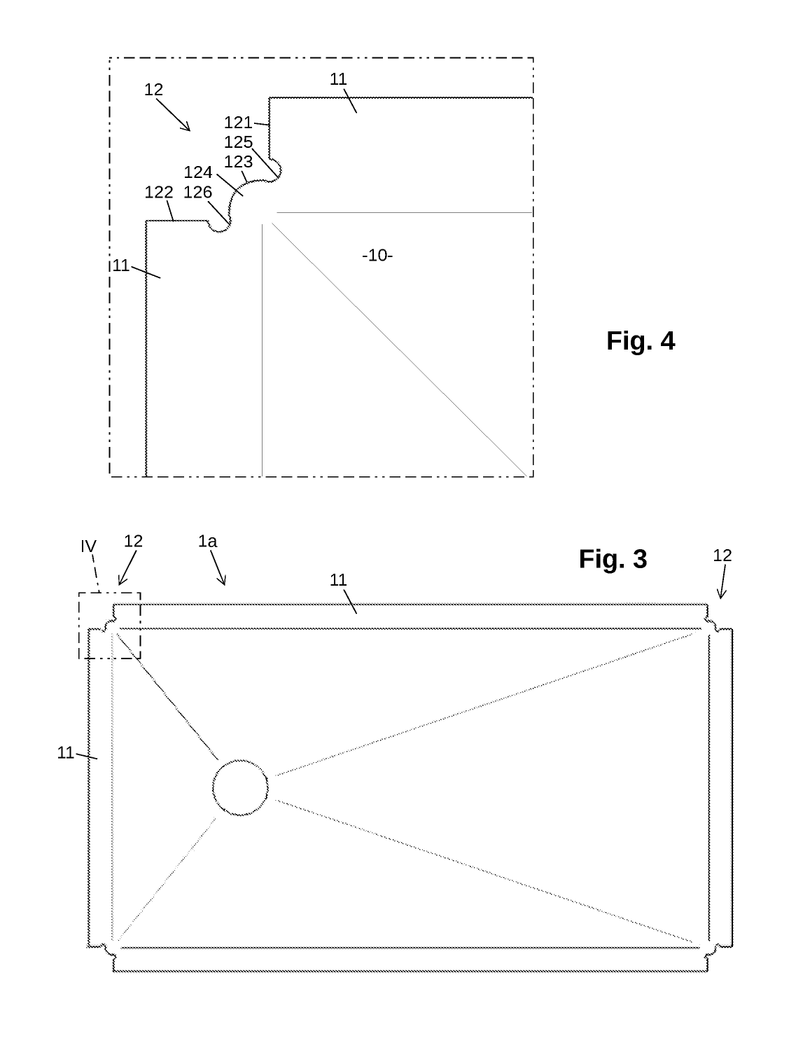

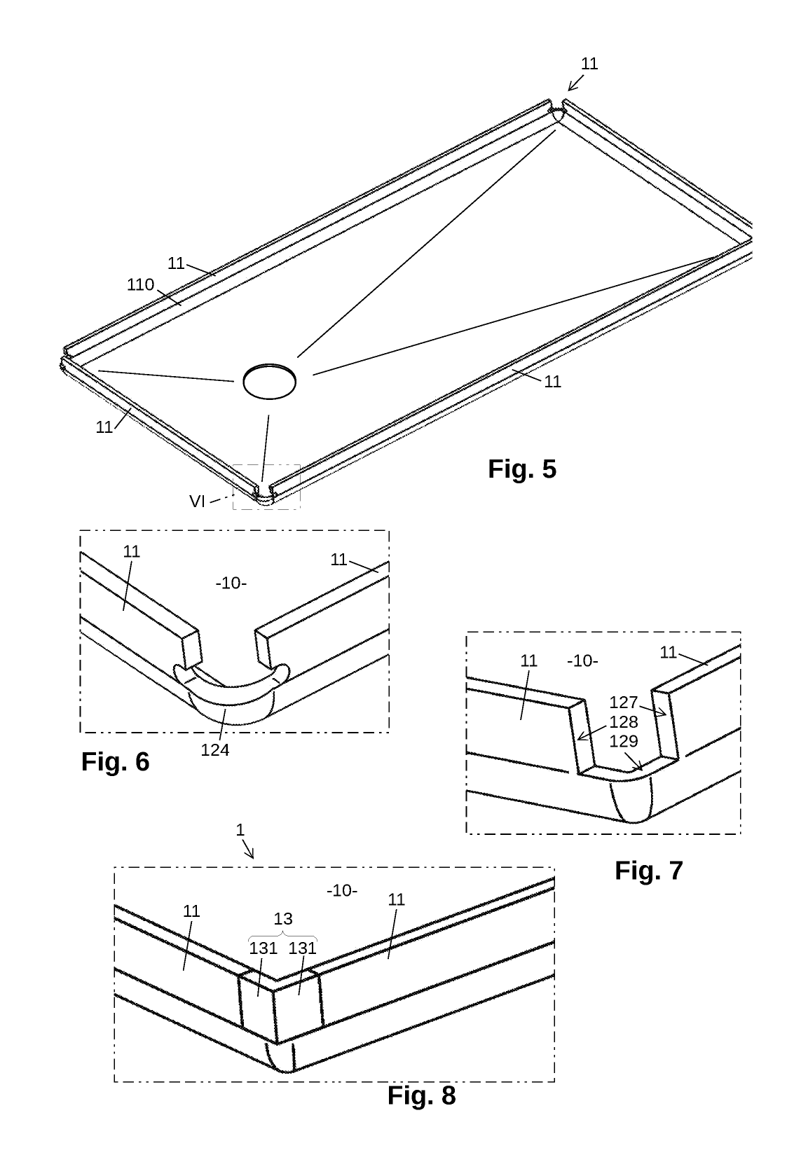

For the fabrication of the shower tray 1, the process is as follow:
selecting a rectangular or square plate 1a made of thermoplastic material, the plate 1a having four corners 12. The thickness is around 8 to 15 mm, preferably between 10 to 12 mm.
cutting each corner 12, as shown on FIGS. 3 and 4. Each cut is made on the total thickness of the plate and comprises, in a plane of the plate 1a, a first line 121 perpendicular to one of the edges 11 of said corner 12, a second line 122 perpendicular to another of the edges 11 of said corner 12, an arcuate line 123 between the first and the second lines 121, 122 defining a convex limit 124, and a first and a second recess portions 125, 126 joining the arcuate line 123 and respectively the first and the second lines 121, 122.
heating the plate to soften it;
forming the plate on a mold, not shown, to raise the convex limit 124 at each corner 12 and the edges 11 between the cuts, in particular between the recess portions 125, 126 as shown on FIGS. 5 and 6. The junctions 110 between a central portion of the plate forms the bottom 10, and each raised edge 11 are curved. Preferably, the bottom 10 is formed in depression to allow the water to flow towards a drain (sink hole) 14. Each edge 11 is bent at the same distance of the limits of the plate so that the edges 11 are raised at the same level, for example at 30 to 60 mm above the bottom 10.
milling the raised edges 11 and the convex limit 124 along the first and second lines 121, 122 and the arcuate line 123. By milling, the recess portions 125, 126 are no longer present and three planar faces 127, 128, 129 are created, as shown on FIG. 7.
bonding the angle piece 13 on three faces to join raised edges 11 at each corner 12 at the same level as the raised edges 11.

The sink hole 14 can be created before the thermomolding of the plate or later.

The shower tray 1 can be used as such in a shower room.

But it can also be used for the fabrication of a shower cubicle 2, as shown on FIG. 2, wherein two panels 21, 22 are raised in prolongation of two adjacent raised edges 11 and are joined by bonding, forming two side walls of the cubicle 2. The panels 21, 22 are displayed only partially on the FIG. 2. The panels 21, 22 can comprise the same or different material as the shower tray 1. The second panel 22 is joined with the first panel 21 without rounded portion by bonding. The angle of the junction extends on the angle piece 13 and on the junction between the curved junction parts 110.

The invention is not limited to the embodiment shown an example. The junction at corner could be with a rounded portion which extends and disappears on the angle piece. This junction could also include a fillet which extends on the angle piece and along the junction between the two side walls 21, 22 with a junction piece. The corners can be at any angle value, such as 120° or 135°.

If cuts are made giving greater length to the edges and with deeper recesses, the raised edges can be joined directly, without using an angle piece. The convex limit is thus raised to abut the raised edges at their junction.

1. A process of fabrication of a shower tray comprises the steps of:
selecting a plate of thermoplastic material, the plate having corners;
cutting at least one corner along an outline, each outline comprising, in a plane of the plate, a first line perpendicular to one of the edges of said corner, a second line perpendicular to another of the edges of said corner, an arcuate line between the first and the second line defining a convex limit, and a first and a second recess portions joining the arcuate line and respectively the first and the second line;
heating the plate to soften the plate;
forming the plate in a mold by thermomolding to raise the convex limit at the at least one corner and the edges of the plate extending from said corner, in particular from the recess portions, the junction between a central portion of the plate, forming a bottom, and each raised edge being curved to form a curved junction part; and
joining raised edges at each corner.

2. The process of claim 1, wherein raised edges are joined at the corner by bonding an angle piece between the raised edges.

3. The process of claim 2, wherein before bonding an angle piece, the raised edges and the convex limit are milled along the first and second lines and the arcuate line to enclose the recess portion and to create three planar faces, the angle piece being bonded on said three faces.

4. The process according to claim 2, wherein the angle piece raises at the same level as the raised edges.

5. The process according to claim 1, wherein the junctions between the bottom and the raised edges are joined at the corner without a rounded portion.

6. The process according to claim 1, wherein when forming the plate, the bottom is formed in depression.

7. The process according to claim 1, wherein the plate is made of a material comprising acrylic resin with mineral filler.

8. The process according to claim 7, wherein the mineral filler comprises alumina trihydrate and consists of more than 60% of the mass of the material.

9. A process of fabrication of a shower cubicle, wherein a shower tray is made according to claim 1, and wherein at least one panel is raised in prolongation of one of the raised edges.

10. The process of claim 7, wherein a second panel raised in prolongation of one of the raised edges and joined with the first panel without a rounded part.

11. A shower tray in thermoplastic material, comprising:
a bottom;
raised edges along the bottom and extending from at least one corner of the bottom, the junction between the bottom and each raised edge being curved to form curved junction parts; and
a bonded junction at the corner between the raised edges.

12. The shower tray according to claim 11, wherein the shower tray comprises an angle piece joining raised edges at least at a corner bonded at said corner on three faces, the angle piece comprising two flanges, each flange being abutted against one of the raised edges of said corner.

13. The shower according to claim 11, wherein the curved junction parts are joined at the corner without rounded portion.

14. The shower according to claim 11, wherein the plate is made of a material comprising acrylic resin with mineral filler.

15. The shower according to claim 14, wherein the mineral filler comprises alumina trihydrate and consists of more than 60% of the mass of the material.

16. A shower cubicle in thermoplastic material, comprising:
a bottom;
raised edges along the bottom and extending from at least one corner of the bottom, the junction between the bottom and each raised edge being curved to form curved junction parts;
a bonded junction at corner between raised edges; and
at least a first panel raised in prolongation of one of the raised edges.

17. The shower cubicle of claim 16, wherein an angle piece joins raised edges bonded at least at said corner on three faces, the angle piece comprising two flanges, each flange being abutted against one of the raised edges of said corner.

18. The shower cubicle according to claim 16, comprising a second panel raised in prolongation of one of the raised edges and joined with the first panel without a rounded portion.
